(19) United States
(12) Patent Application Publication
(10) Pub. No.: US 2002/0126672 A1
(43) Pub. Date: Sep. 12, 2002

(54) Method and apparatus for a flexible and reconfigurable packet classifier using content addressable memory

(76) Inventors: Nelson Chow, Mountain View, CA (US); Fangli Chien, San Jose, CA (US)

Correspondence Address: Rosemarie F. Jones, Esq., Haller Ehrman White & MacAuliffe LLP, 275 Middlefield Road, Menlo Park, CA, 94025, US

(21) Appl. No.: 09/758,884

(22) Filed: Jan. 10, 2001

(51) Int. Cl. H04L 12/56

(52) U.S. Cl. 370/392; 370/401

(57) ABSTRACT

The present invention provides for a reconfigurable packet classifier using CAM. The invention is directed to packet classification for switching/routing systems where the router's system resources are limited and the customer requirements from the router are variable. The invention addresses the CAM constraint (e.g. search key width) problems of CAM-based classification systems, by allowing a reconfigurable selection of packet fields and/or payload bits to be used in the definition of the search key. For any given incoming packet, a subset of that incoming packet may be statically chosen to fit that particular CAM architecture and to create a particular CAM search key. This provides router deployment flexibility within networks and, thus, cuts costs.

### BACKGROUND OF THE INVENTION

1. Field of the Invention

This invention relates generally to computer networks, and in particular to routers and switches.

2. Description of the Related Art

Routers connect dissimilar networks, such as those within the Internet, thus creating an illusion of a unified network. Their primary role is to transfer packets from a set of input ports belonging to certain networks to a set of output ports belonging to other networks. Because different types of information travel through networks, e.g., the Internet, it is often useful for routers to be able to give differential treatment to packets of information (packets). Routing, access-control in firewalls, policy-based routing, provision of differential qualities of services, traffic billing, web server load balancing, network address translation, and the like are examples of the current treatments that may be applied. (Routers and switches are herein used interchangeably, and generally refer to the network device that operates at the L3 network layer and above. The term “layer” herein refers to those defined in the OSI (Open Systems Interconnection) Reference Model. A packet or packet information typically comprises a header, a payload, and some combination of packet status information as shown in FIG. 3. Headers and payloads further consist of various fields defined, for example, by the network protocols. Packet type and structure information refers to which network protocols a certain packet belongs, as well as to the location of this protocol information within the packet.)

To transfer packets of information, it is necessary for routers to determine the flow to which a packet belongs so as to determine which type of treatment should be applied. A flow refers to the group of packets with certain characteristics that obey a particular rule/policy. (The term “rule” herein is used interchangeably with “policy” and specifies a set of criteria on packet information.) A flow, for example, could be defined by a layer 4 address, made up of the five-tuple (destination IP, source IP, destination L4 port number, source L4 port number, and protocol) of packet information. A flow may also have a complex structure, for example, as a combination of fields extracted from the packet information, such as from the header, the packet payload, and/or from the packet status information (e.g., packet length, ingress/egress port, time stamp, and the like.) Likewise, a flow could be simply defined by the set of IP destination addresses described by a common prefix, in which packet classification reduces to what is called longest prefix match IP routing lookup.

Routers identify these flows by matching incoming packets with a set of prespecified filters, called rules/policies, where each flow obeys at least one rule/policy. Such rules/policies are typically stored in a classification database or rule/policy lookup database. Since each flow may also belong to multiple policies, it is the most specific or longest matching policy that should be returned. For example, consider a classification database with two rules, one with rule “from ISPx” (Rule 1) and the other with rule “from ISPx between the hours of 1AM to 2AM” (Rule 2). All packets that are email and from ISPx constitute a flow that matches Rule 1. All packets that are from ISPx during 7AM to 9AM also constitute a flow that matches Rule 1. But note that a packet arriving into this router satisfying Rule 2 will also match Rule 1, but since Rule 2 is more specific, it is Rule 2 that should be returned.

The categorization function described above is performed by a packet classifier (also called a flow classifier). Generally, any combination and length of information obtained from the packet can be used in packet classification. Because packet classification needs to be performed for each incoming packet and a router's performance is based on how quickly it can forward a packet, this has been one of the main bottlenecks in router design.

Traditionally, the speed of a classification/lookup algorithm is determined by the number of memory accesses it requires to find the matching entry and the speed of the memory. A tree is a standard data structure to store flows, wherein each path in the tree from root to leaf generally corresponds to an entry in the rule/policy lookup database. In order to find the longest prefix match, for example, one must find the longest path in the tree (flow) that matches the desired search information of the incoming packet. A tree-based algorithm, conceptually, starts at the root of the tree and recursively matches the children of the current node, stopping if no other match is found. Thus, in worst case, it takes time proportional to the length of the search information to find the longest prefix match. These tree-based algorithms make frugal use of memory at the expense of doing more memory lookups. Such algorithms, however, may not be wise considering that memory prices drop quicker than memory latency.

Content addressable memories (CAMs) in routers have been used to improve the performance of classification algorithms. The classification database is stored as a content of the CAM. CAMs perform a parallel search of all the entries in the classification database, thereby obviating the need for recursive searches into a regular memory. Referring to FIG. 1, CAMs generally perform classifications in two phases: the search phase 110 and the action phase 120. As a packet 102 arrives into the router 100, the packet 102 is parsed 104 by the router and search information is collected from the packet header and payload, aggregated to form a search key 108, which is then used as the lookup index into the CAM's classification database 106. Due to the parallel lookup nature of a CAM, a result can be returned in O(1) time. The resulting content address or entry address 112, matching the search key 108, obtained from the classification database 106 is then used to perform a memory read into an associated memory 122, which contains the specific actions 124 that should be applied to the packet (e.g., metering and shaping parameters, quality of service provisions, packet counting and billing actions, DSCP remarking, CPU actions, etc). This search key generation, followed by CAM and associated content lookup, constitute a CAM-based lookup engine.

While the use of CAM memories marks a performance improvement over other software and dedicated hardware lookup techniques, it does have drawbacks. The maximum width of the search key is fixed by the CAM vendor, thus representing a very strict constraint on how much packet data can be used to perform a search into the classification database. Depending on the network topology in which the router is placed, various CAMs may be needed to implement the needs of the network. Furthermore, the search information extracted from the packet is dictated by the CAM configuration as purchased from CAM vendors. In determining what fields in the packet are to be used, the maximum search key allowable is dictated by a bit budget. Some complex rules, therefore, cannot be specified, due to the lack of bit space.

Table I, below, for example, shows that a minimum of at least 215 bits may be required out of the packet information to provide classification support for full multi-layer quality of service (QOS) and web switching functions. Currently, no CAM vendor can support search keys that are this wide. Support for these types of widths would be detrimental to both the cost and bandwidth of CAM, as well as increase the pin count of the controlling ASIC (Application Specific Integrated Circuit) driving the CAM.

TABLE I
Search key for IP Packet

| | No. of Bits | Description |
|---|---|---|
| Destination Mac Address | 48 | Destination Mac Address |
| Source Mac Address | 48 | Source Mac address |
| L2_priority | 3 | 802.1p user priority |
| Source IP | 32 | Source IP address |
| Destination IP | 32 | Destination IP address |
| Protocol Type | 8 | Protocol type |
| Source Port | 16 | Source TCP/UDP ports |
| Destination Port | 16 | Destination TCP/UDP |
| | | ports |
| DSCP | 6 | DSCP value |
| Input Ports | A | Input ports |
| Output Ports | B | Output ports |
| TCP flag | 6 | Flag bits in TCP header |
| Total | 215 + A + B | |

Given a fixed, narrow search key width, a sacrifice must be made in selecting which fields from the packet information can be used as criteria for classification. This may result in classification functions that are not as complete as desired. In addition, depending on where the router is located in the network topology, the packet classifier will need different sets of information. Once the CAM controlling hardware, however, is designed, the packet information contributing to the search key will be fixed, thereby making that specific router's role in the network topology also fixed.

There currently exists a group of processor-like products (e.g. network processors, network co-processors, and the like), similar to some microprocessors, which may be programmed and/or reprogrammed using complex instructions from a special programming language set. A certain amount of expertise and skill set, however, is needed to effect programming or changes to these network (co)processors. A way to effect changes to these coprocessors without the requisite programming skill set is highly desirable.

From the discussion above, it is apparent that there is a need for an improved CAM classification technique using existing CAMs to enable flexibility of router deployment within networks and to cut costs, without the necessity of learning any high level programming skill set. The present invention fulfills this need.

### SUMMARY OF THE INVENTION

The present invention provides for a reconfigurable packet classifier using content addressable memory (CAM). The invention is directed to packet classification for switching/routing systems where the router's system resources are limited and the customer requirements from the router are variable. The invention addresses the CAM constraint (e.g. search key width) problems of CAM-based classification systems, by allowing a reconfigurable selection of packet fields and/or payload bits to be used in the definition of the search key. For any given incoming packet, a subset of that incoming packet may be statically chosen to fit that particular CAM architecture and to create a particular CAM search key. This provides router deployment flexibility within networks and, thus, also cuts costs.

In one aspect, the invention provides for a method of classifying packet information using CAM. The method comprises the step of receiving a set of reconfigurable selection criteria from a user wherein such selection criteria is limited by a CAM constraint. Optionally, packet information may be received. Based on the received packet information, the packet structure is determined. The received packet information is also stored in a packet memory. Using the packet structure and the set of selection criteria, a bit mask is generated at run time. Using the bit mask generated and packet information stored in packet memory, a search key is created. Optionally, this search key may be used to search the classification database contained in a CAM to determine the policy of the packet information received.

In another aspect, the invention provides for a CAM controlling hardware, which receives a set of reconfigurable selection criteria, limited by a CAM constraint. The CAM controlling hardware may also perform the operations or features described above.

In another aspect, the invention provides for an integrated circuit containing a CAM controlling hardware, which performs the operations or features described above.

In another aspect, the invention provides for a packet classifier system comprising a CAM controlling hardware that generates a CAM search key based on a set of reconfigurable selection criteria provided by a user and a bit mask generated at run time based on the packet structure of a packet information received, and a packet memory.

In another aspect, the invention provides for a router or switch comprising an integrated circuit containing a CAM controlling hardware which interfaces with an ingress manager by receiving packet information, which interfaces with a CAM to do a search or lookup on the classification database contained in the CAM, which interfaces with an action content database (RAM/Memory) to do a memory read, and which interfaces with an egress manager which sends out packet information.

In another aspect, the invention provides for a method of enabling a user to reconfigure a router or switch. In the first operation, the method provides a user interface wherein a user is able to define a set of reconfigurable selection criteria to determine a CAM search key. In the next operation, the method receives the selection criteria defined by the user. The method, optionally, also provides information regarding the CAM constraint.

The invention also provides for a software program product and a system that implements the method described in the preceding paragraph.

The use of the invention allows flexibility in the choice of packet fields, thereby providing a router with reconfigurable classification functions, without any complex programming. This would reduce the cost of replacing routers, allow routers to be placed anywhere within the Internet topology, and allow routers to simultaneously meet different market requirements. For example, routers that use our invention could be configured as any combination of a basic Layer 2 switch, basic Layer 3 switch, basic IPX Layer 3 switch, basic Layer 4 switch, a Differentiated Services compliant router (both BA and MF), an IP filtering and Layer 2 QOS, IP Layer 2-3 QOS, and IP Layer 2-4 QOS compliant router, and a Web Switch (Layer 7 switch). In addition, as demands from the Internet change, and new protocols are established/changed, the same router will be able to handle this new environment through a simple static configuration. This invention enables the SAME router to be placed in different topologies of networks, without the need to replace the router.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram representation of a traditional CAM-based classification algorithm.

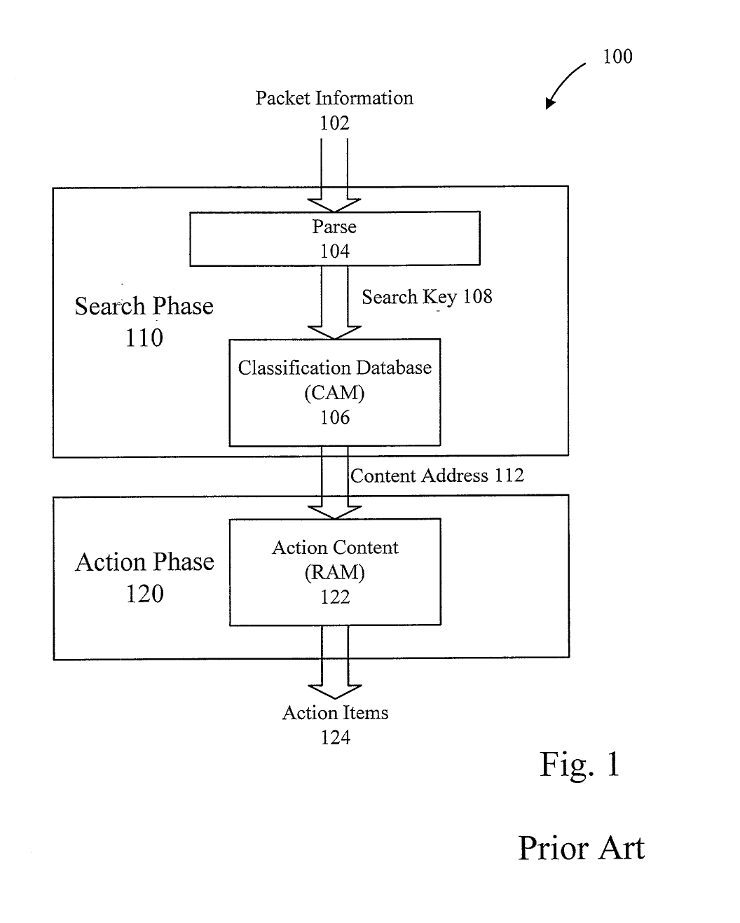

FIG. 2 is a block diagram representation of a data flow using a configurable CAM-based classification algorithm constructed in accordance with the present invention.

FIG. 3 contains exemplary fields that may be selected as part of the search key in accordance with the present invention.

FIGS. 4a and 4b contain exemplary predefined classification templates in accordance with the present invention.

FIG. 5 is a block diagram illustrating in detail the reconfigurable buffet selector/parser constructed in accordance with the invention.

FIG. 6 is a block diagram illustrating in detail the search key generator constructed in accordance with the invention.

FIG. 7A illustrates an exemplary CAM search key based on a sample incoming packet and a set of reconfigurable selection criteria provided.

FIG. 7B illustrates in general the operations involved in obtaining a search key considering the scenario illustrated in FIG. 7A.

FIG. 8 illustrates a high-level block diagram of a router constructed in accordance with the present invention.

FIG. 9 illustrates one basic embodiment of a system constructed in accordance with the present invention wherein an intelligent software enabling a user to define a search key is deployed.

FIG. 10 is a block diagram of an exemplary computer, which may contain an intelligent software enabling a user to define a search key.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives, and uses of the invention, including what we presently believe is the best mode of carrying out the invention.

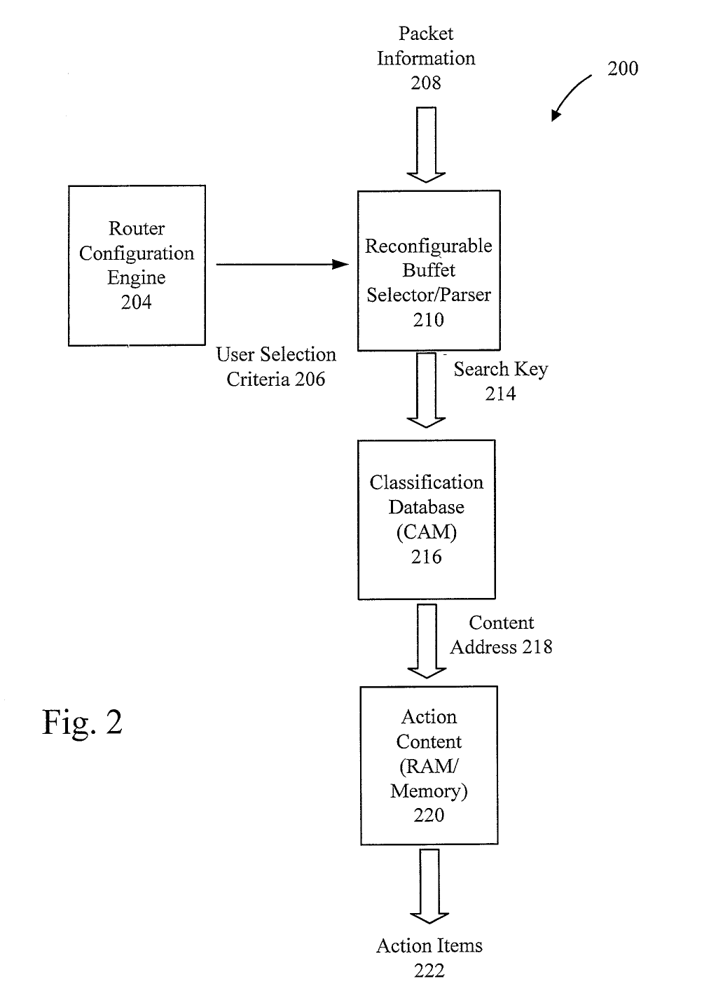

FIG. 2 illustrates a block diagram representation of a data flow using a configurable CAM-based classification algorithm 200 constructed in accordance with the present invention. To configure a switch or a router constructed in accordance with the present invention, a user, typically a network system administrator, first decides where the router 200 is to be placed within the network topology so as to determine the classification functions needed to be performed by such router. Knowing this information and with the help of an intelligent router configuration software, the user chooses the fields and payload bit positions to determine a set of search classification or selection criteria (“selection criteria”), depending on the type of incoming packet information, using the router's configuration engine 204.

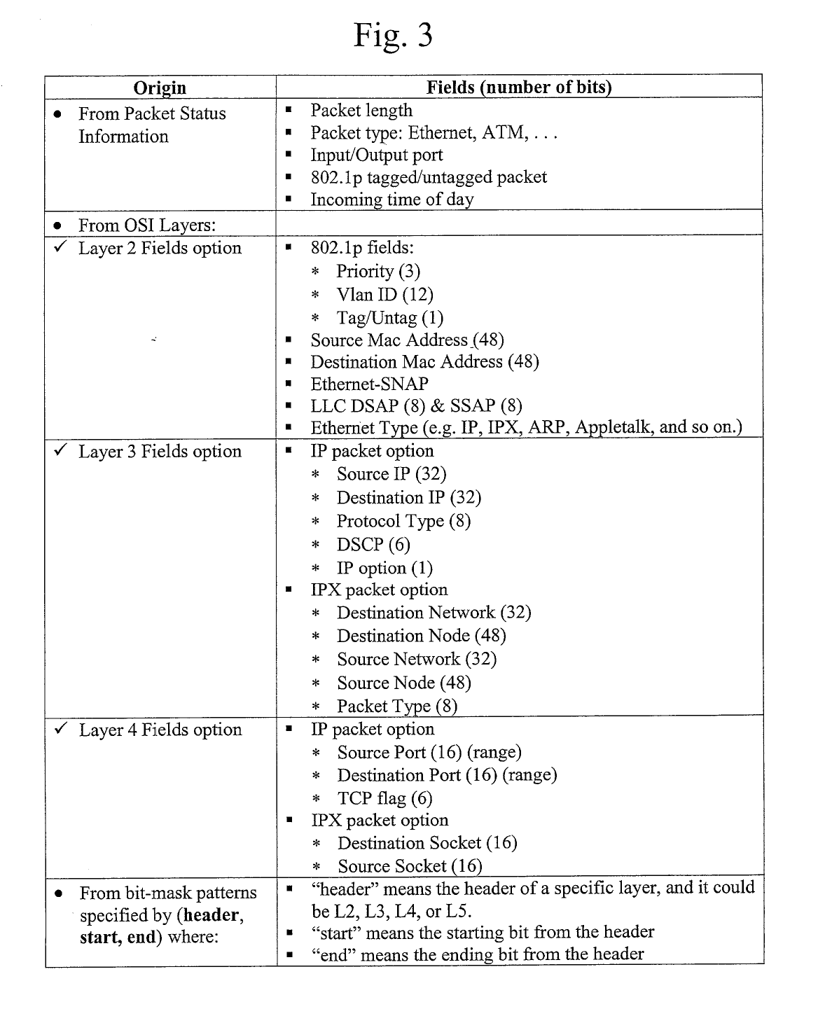

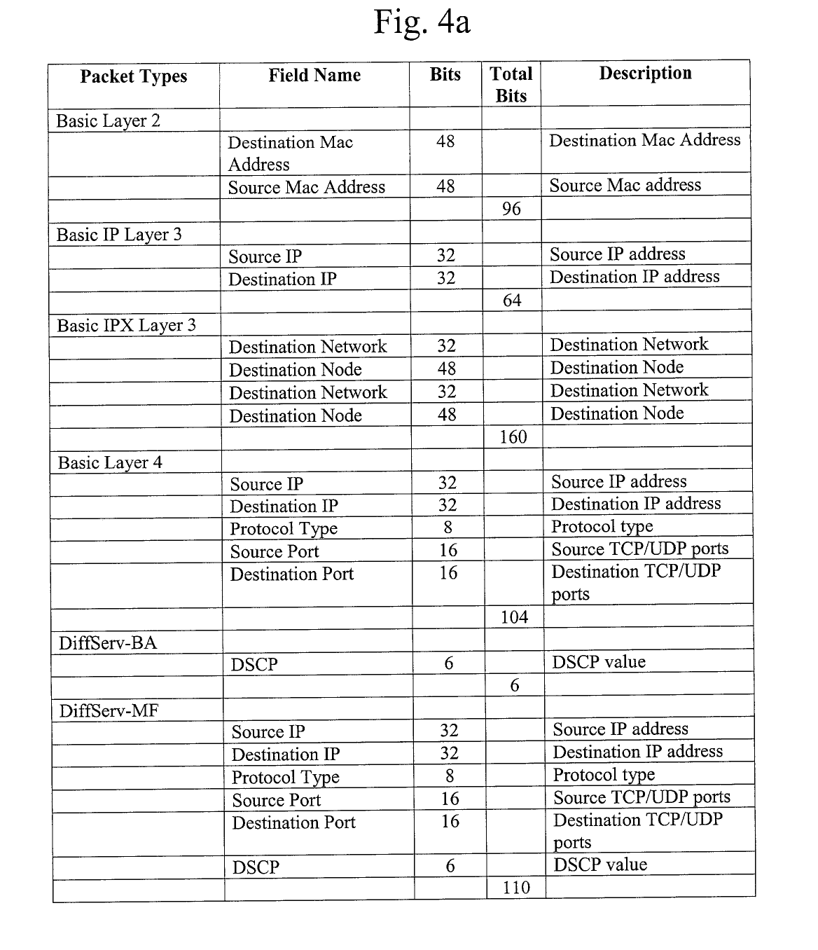

During router configuration, an intelligent software or a graphical user interface (GUI) may be implemented to enable and assist a user to define or input the user's selection criteria or configuration data (e.g., the fields and payload bit positions). This software may also assist the user in defining the search key by presenting a list of predefined classification templates, e.g., those shown in FIGS. 4a and 4b, from which the user may choose. Available fields from network protocols, for example those shown in FIG. 3, may also be displayed from which the user may choose. The selection criteria may be a combination of selection from the presented available fields and/or predefined classification templates. The predefined classification templates may be stored in a data store (e.g., file systems) or in a database, such as a relational database management system (RDBMS). When new network protocols are defined or if any existing network protocols are changed or become outdated, the corresponding data store or database is updated accordingly to capture these changes. This software may also be aware of the logical relationships between network protocols. For example, if the user has chosen any IP packet fields, fields available from IPX packet information thus become unavailable for selection (see FIG. 3, Layer 3 Fields option). This is because the intelligent software is aware that once IP packet fields are selected, the user will not or should not choose fields from an IPX packet. Moreover, this software may also be aware of the existing CAM constraint, e.g., the CAM search key size restriction. The software, thus, may display information regarding the CAM, such as this size constraint, by alerting the user to the remaining number of bits left to create the selection criteria that would fit in the CAM constraint, by alerting the user that the selection criteria exceeds the allowable CAM search key, and the like.

The available fields discussed above may originate from three distinct categories in the packet information, namely, from the packet status information, from specific fields in any OSI layer of any network protocol, and from bit-mask patterns at any position in the packet (see FIG. 3). Considering that the fields to create such classification templates are defined from the currently available set of network protocols, as existing protocols and requirements change, and new ones are introduced, the present invention may be modified to consider new protocols. FIG. 3 contains the sample fields that may be used to create the classification templates of FIGS. 4a and 4b.

Referring back to FIG. 2, after the user has defined or provided the classification criteria or selection criteria using the router configuration engine 204, the user selection criteria information is then used by the reconfigurable buffet selector/parser 210 to extract bits from the incoming packet information 208 and to also generate the search key 214, which is then used for the lookup into the CAM's classification database 216.

The reconfigurable “buffet” selector/parser 210 is reconfigurable as opposed to programmable, i.e., no programming is required from the user. All the user has to do is to define the selection criteria by determining the fields and the payload bit positions desired to form the resulting search key. (The box 210 also called “buffet” because of the resemblance to buffet style restaurants, where the available set of food items is displayed, and one is limited in selection only by the plate size. The combination of items chosen determines what sort of classification system is implemented (or the selection criteria defined) or, analogously, what sort of meal one wishes to eat.)

The resulting content address or entry address 218, matching the search key 214, obtained from the classification database 216 is then used to perform a memory read into an associated memory 220, which contains the specific actions 222 that should be applied to the packet. For example, an Internet Service Provider router that needs to perform packet filtering, policy routing, accounting and billing, traffic rate limiting, and traffic shaping may use the present invention to access certain fields from the incoming packet information, notably, the destination IP, source IP, destination L4 port number, source L4 port number, and protocol.

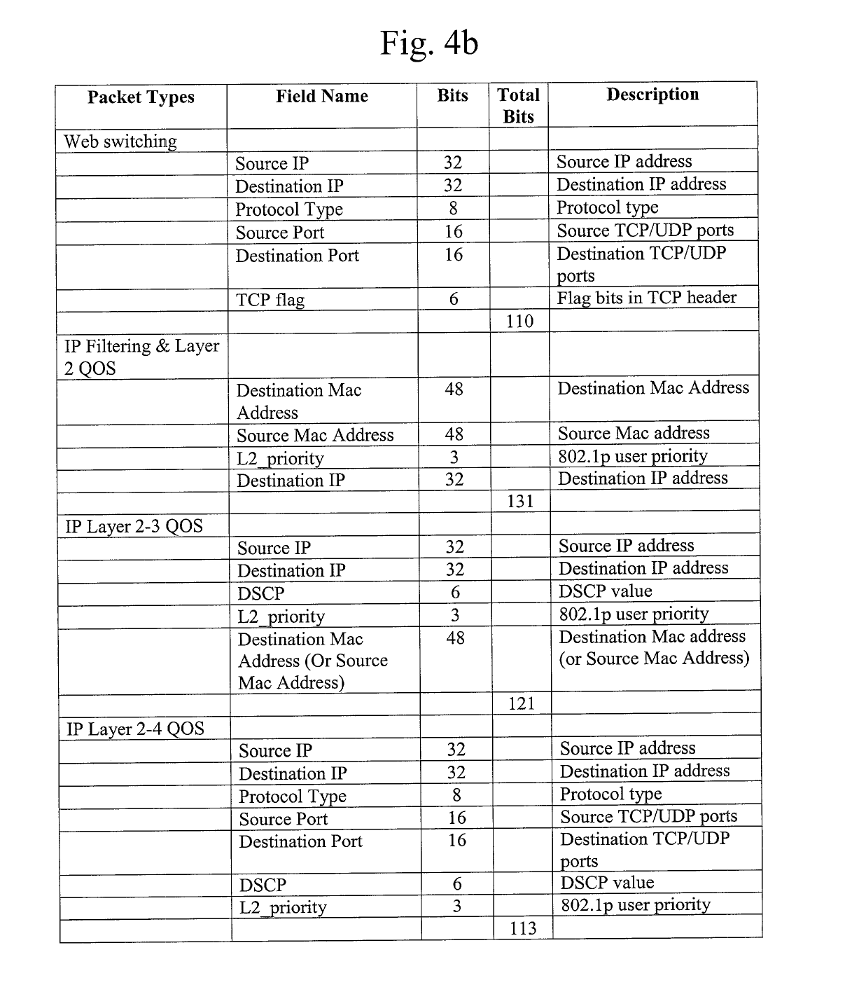

FIG. 5 illustrates in detail the reconfigurable buffet selector/parser 210 (FIG. 2) constructed in accordance to one embodiment of the present invention. As shown, once the user defines the selection criteria 206 using the router configuration engine 204, e.g., the intelligent software, the user selection criteria information 206 is passed to the reconfigurable buffet selector/parser 210, in particular to the packet bit mask generator 502. The router 200 (FIG. 2) is generally statically configurable. Once the set of classification or selection criteria is programmed and running in the router, the user may not reconfigure the router to perform or function in other network topologies. In order to do so, the router with the reconfigurable buffet selector/parser 210 generally should be shut down, and brought up again and reconfigured with the desired classification criteria or selection criteria.

The incoming packet 208 is received by the reconfigurable buffet selector/parser 210, in particular, by the packet parser 504. The incoming packet 208 is then received and stored by the packet memory 506, as shown by the arrow 516. The packet parser 504 also reads the incoming packet 208 to determine the type and structure of such packet. This packet structure information 510 is then sent to the packet bit mask generator 502, as shown by the arrow 510. The packet bit mask generator 502 also receives the user's selection criteria information 206. Using the packet structure information 510 and the user's selection criteria 206, the packet bit mask generator generates at runtime a complete bit mask 518 (for each incoming packet), which is then sent to the search key generator 508. This bit mask has the same length (i.e., equal number of bits) as the length of the incoming packet 208. The positions of fields (i.e., their particular bits) and/or payload bits that were selected by the user to form the selection criteria 206 are marked with “1” in the bit mask. The search key generator 508, using the bit mask received 518 and packet information stored in the packet memory 506, generates the search key 214 to be used as a lookup into the CAM's classification database 216 (FIG. 2).

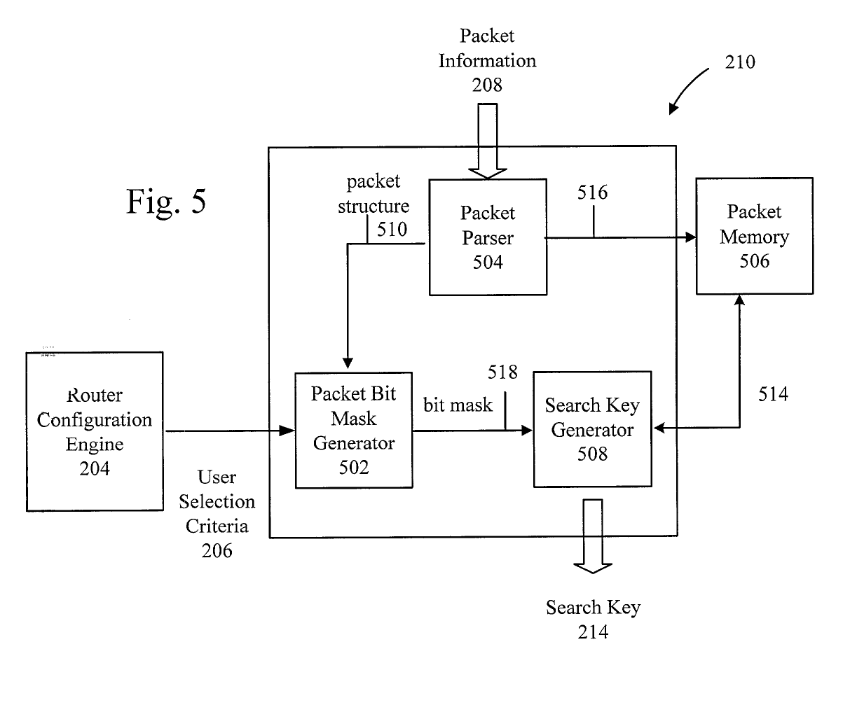

FIG. 6 illustrates the search key generator 508 in detail. The search key generator 508 may be implemented in a variety of ways. FIG. 6 illustrates three ways: Approach A 602 shows a sequential serial implementation; Approach B 610 shows a semi-parallel approach; and Approach C 620 shows a fully parallel implementation.

Referring to Approach A 602, the complete bit mask 518 received by the search key generator 508 is first received by the mask pass bit locator 604, which outputs the index location of each “1” in the bit mask (indicating the position of each bit chosen as part of the selection criteria). The complete bit mask 518 is sequentially and serially read. The output is performed n times, where n is the width of the CAM search key around which the classifier is built. Thus, if an incoming packet is 1,500 bytes (12,000 bits) and the CAM search key width is 144 bits, the resulting output 606, in this example, thus contains 144 “1”s spread out among a bit width of 1500 bytes. (There are 8 bits to a byte). Each time the index location of one of these “1”s is presented, the search key packer 608 extracts the value of that bit location from the packet information received (stored in the packet memory 506 (FIG. 5)) and begins to pack or collect the resulting values to generate or create the CAM search key 214. This operation continues until the complete CAM search key is formed. Approach A is a preferred embodiment if cost of production is an issue.

If faster buffet search key generations are required, one can use a fully combinational circuit, where all “1” index locations in the bit mask 518 are simultaneously presented to a parallel search key generator 622 in one clock cycle (see Approach C 620). The parallel search key generator 622, which receives the complete bit mask 518, then generates the search key 214 in one clock cycle. Similar to Approach A, the index locations of all 1's in the bit mask 518 are determined, the corresponding values retrieved from packet memory 506, and the values retrieved are packed or collected to generate the CAM search key 214, but all in one clock cycle. This approach, while faster than Approach A 602, will likely consume tremendous quantities of logic (due to the width of the bit mask and search key).

Another approach, Approach B 610, is to combine Approach A 602 and Approach C 620, but this time processing not just one bit at a time (as Approach A 602) or processing the entire bit mask 518 (as Approach C 620), but to take, for example, multiples of 16 bits. This results in a compromise in both the computation time and hardware resources. The submask generator 612, which receives the complete bit mask 518, generates a submask and a portion of the search key in one clock cycle. Using the example illustrated in Approach A, and assuming that the packet information contains 1,500 bytes (12,000 bits) and the submask generator 612 processes 16 bits per cycle, the submask generator 612 determines the index locations of all 1's in each 16-bit submask and the search key packer 616 accordingly retrieves the corresponding values from packet memory 506. In this scenario, the approach uses seven hundred fifty (750) cycles to process the 12,000 bits to generate a search key 214.

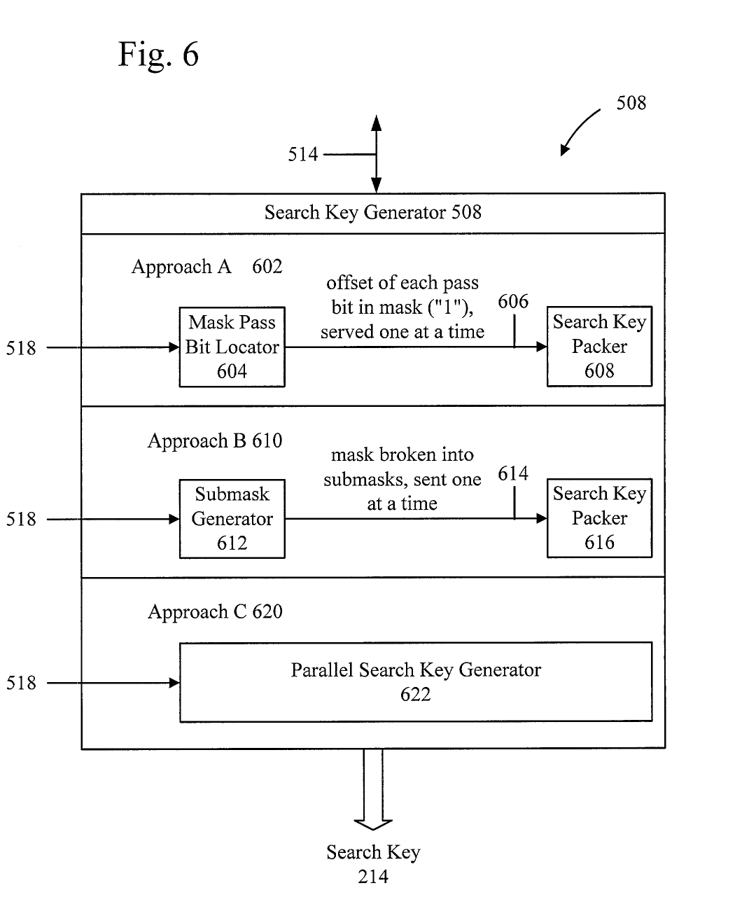

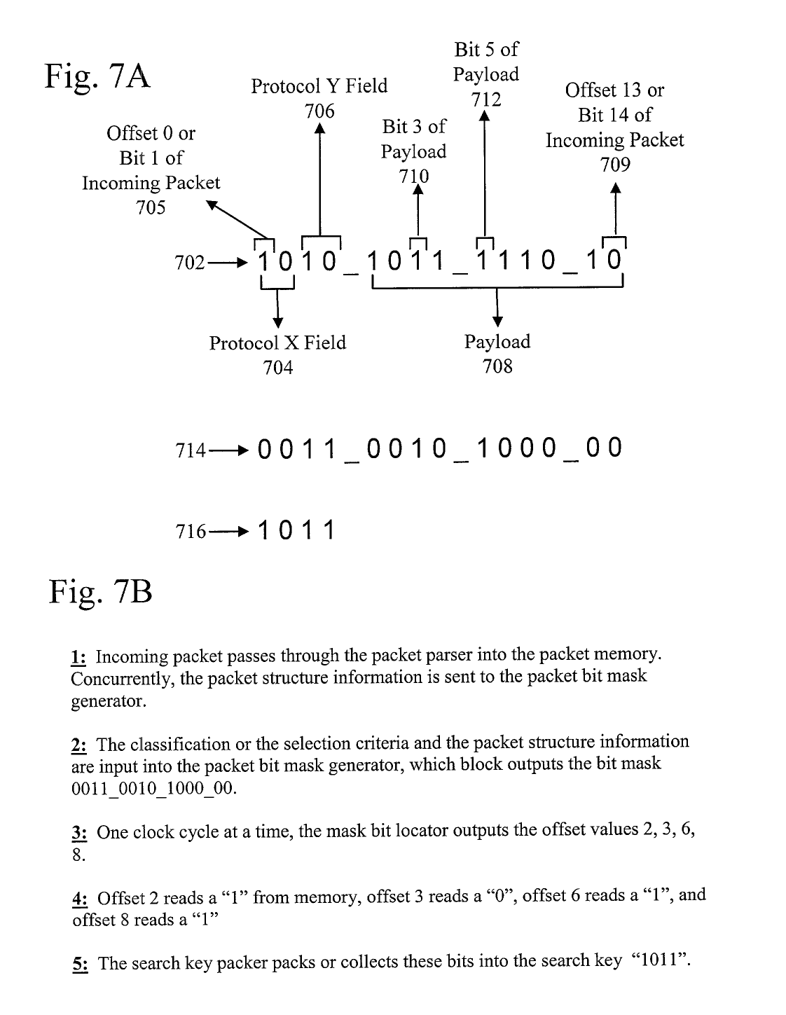

To illustrate the invention, particularly Approach A 602, please refer to FIG. 7A. FIG. 7A illustrates an exemplary incoming packet 702, the corresponding bit mask 714 generated, and the CAM search key 716 generated used as a lookup into the CAM's classification database. In this example, a packet containing 14 bits (“1010_{—}1011_{—1110}_{—}10”) is received by the reconfigurable buffet selector/parser 210 (FIG. 2). The protocol X field 704 is contained in the first two bits, the protocol Y field 706 is contained in the next two bits, and the payload 708 is contained in the next 10 bits of the packet 702. The CAM search width, constrained by the CAM manufacturer (as discussed above), in this example, is 4 bits wide. In this case, the user selection criteria information, generally dependent on the router's desired function(s), is defined by the user to be the protocol Y field 706, and the third 710 and fifth 712 bits of the payload 708. The first bit (bit 1) 705 of the packet 702 is also considered to be offset 0, while the last bit (bit 14) 709 is considered to be offset 13.

In this example, incoming packet 702 (208 in FIG. 5) is received by the packet parser 504 (FIG. 5) and then sent to the packet memory 506 (FIG. 5) to be stored. The packet parser 504 also determines the packet structure 510 (FIG. 5). The selection criteria 206 (FIG. 5) and the packet structure information 510 are received by the packet bit mask generator 502 (FIG. 5), which then generates the bit mask 518 (FIG. 5), which in this case is bit mask 714 (“0011_{—}0010_{—}1000_{—}00”). Each bit of the selection criteria is identified by putting a “1” bit in that bit position. One clock cycle at a time, the mask pass bit locator 604 (FIG. 6) reads each bit of the bit mask 518 and accordingly, outputs the values of offsets 2, 3, 6, 8 (bits 3, 4, 7, and 9) read from the packet memory 506 (i.e., the locations where a “1” is found in the bit mask). Offset 2 (first bit of protocol Y field 706) reads a “1,” offset 3 (second bit of protocol Y field 706) reads a “0,” offset 6 (710) (third bit of payload 708) reads a “1,” and offset 8 (712) (5th bit of payload 708) reads a “1.” The search key packer 608 generates the CAM search key 716, i.e., “1011.” FIG. 7A is for illustration purposes only.

FIG. 7B enumerates in general the operations involved in obtaining a search key 214, considering the exemplary scenario illustrated in FIG. 7A.

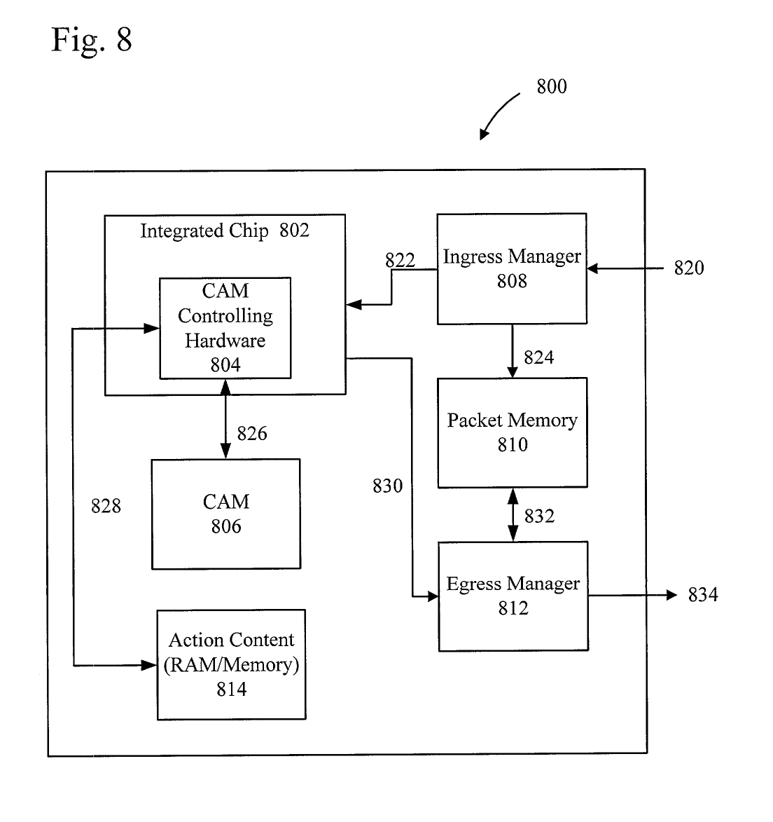

FIG. 8 illustrates a high-level block diagram of a router 800 constructed in accordance with the present invention. The router contains an integrated circuit 802 (e.g., an ASIC), which contains a CAM controlling hardware 804 that implements the features described herein. The router 800 also contains a CAM 806, which may be supplied by various CAM manufacturers. As with other routers, the router 800 also has an ingress manager 808, a packet memory 810, an egress manager 812, and an action content database (RAM/Memory) 814. The ingress manager 808 typically receives the incoming packet information 820 and then sends it to the CAM controlling hardware 804, as shown by the arrow 822. The incoming packet information is also stored in the packet memory 810, as shown by the arrow 824. Using the search key generated by the method described herein, a lookup or search is done on the classification database contained in the CAM (arrow 826). The resulting content address or entry address 218 (FIG. 2), matching the search key 214 (FIG. 2), obtained from the classification database in CAM 806 is then used to perform a memory read into an associated memory 814 (arrow 828), to determine the policy of the packet received as well as the treatment of that packet, as shown by the arrow 826. Depending on the policy received from the CAM controlling hardware 804 and the packet information retrieved from packet memory 810, the egress manager 812 performs some policy action (e.g., metering and shaping, quality of service provisions, packet counting and billing actions, DSCP remarking, CPU actions, etc.), as dictated in the action content database, and sends out the resulting packet 834 to the appropriate network (or receiving port). Variations on how routers are implemented in accordance with the present invention are covered in this application. For example, the router or switch 800 can have an alternative construction, so long as they can support the functionality described herein.

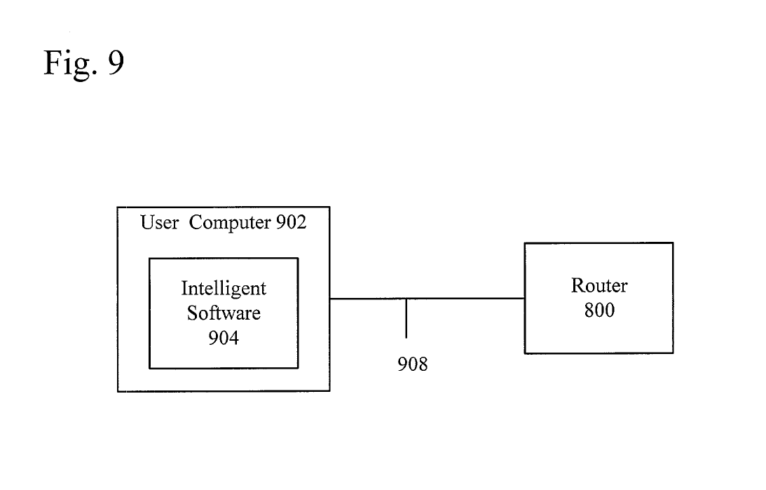

FIG. 9 illustrates one basic embodiment of a system constructed in accordance with the present invention wherein an intelligent software or GUI as described above is deployed. The user computer 902, having a data store, stores or contains such intelligent software 904. The user computer 902 is connected to the router 800 (FIG. 8) via a data network 908, such as a serial line, a local area network, a wireless network, the Internet, and the like. Once the intelligent software 904 is loaded and executed, the user is provided with an interface enabling such user to define a set of selection criteria. Another embodiment, not illustrated in the figure, is wherein the user 902 has access to the intelligent software, but such software is not directly contained in the user's computer (e.g., software contained in a network computer). The intelligent software may be written in a programming language, such as C, C++, and the like. Various configurations on how such intelligent software may be deployed and implemented are known in the art.

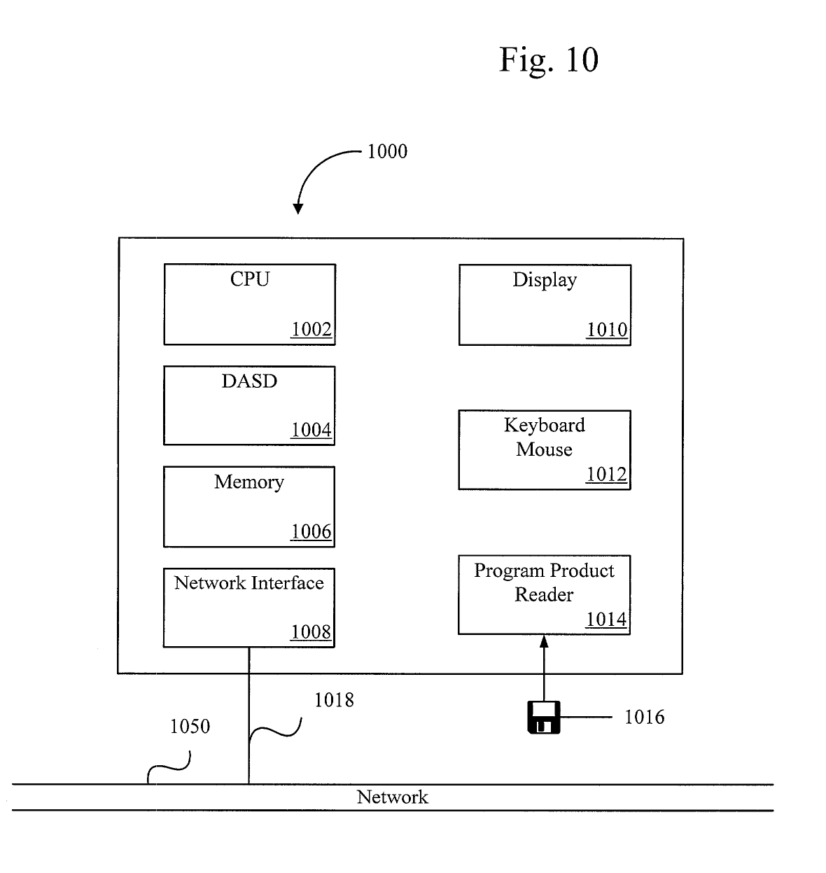

FIG. 10 is a block diagram of an exemplary computer 1000, which may execute the above-mentioned intelligent software as shown in FIG. 9. Each computer 1000 operates under control of a central processor unit (CPU) 1002, such as a “Pentium” microprocessor and associated integrated circuit chips, available from Intel Corporation of Santa Clara, Calif., USA. A computer user can input commands and data from a keyboard and mouse 1012 and can view inputs and computer output at a display 1010. The display is typically a video monitor or flat panel display device. The computer 1000 also includes a direct access storage device (DASD) 1004, such as a fixed hard disk drive. The memory 1006 typically comprises volatile semiconductor random access memory (RAM). Each computer preferably includes a program product reader 1014 that accepts a program product storage device 1016, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, DVD disk, or the like. Each computer 1000 can communicate with other connected computers over the network 1050 through a network interface 1008 that enables communication over a connection 1018 between the network and the computer.

The CPU 1002 operates under control of programming steps that are temporarily stored in the memory 1006 of the computer 1000. When the programming steps are executed, the pertinent system component performs its functions. Thus, the programming steps implement the functionality of the invention, particularly the intelligent software, as described herein this application. The programming steps can be received from the DASD 1004, through the program product 1016, or through the network connection 1018. The storage drive 1004 can receive a program product, read programming steps recorded thereon, and transfer the programming steps into the memory 1006 for execution by the CPU 1002. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1006 over the network 1018. In the network method, the computer receives data including program steps into the memory 1006 through the network interface 1008 after network communication has been established over the network connection 1018 by well-known methods that will be understood by those skilled in the art without further explanation. The program steps are then executed by the CPU 1002 to implement the processing and features of the present invention.

It should be understood that the computer of the system illustrated in FIG. 9, including variations of the system configuration and layout not illustrated, preferably have a construction similar to that shown in FIG. 10. Any of the computers in systems deploying the intelligent software can have an alternative construction, so long as they can support the functionality described herein.

One skilled in the art will recognize that variations in the steps, as well as the order of execution, may be done and still make the invention operate in accordance with the features of the invention.

The present invention has been described above in terms of a presently preferred embodiment so that an understanding of the present invention can be conveyed. There are, however, many configurations for routers or switches with reconfigurable classification system not specifically described herein but with which the present invention is applicable. The present invention should therefore not be seen as limited to the particular embodiments described herein, but rather, it should be understood that the present invention has wide applicability with respect to routers/switches with reconfigurable classification systems. All modifications, variations, or equivalent arrangements and implementations that are within the scope of the attached claims should therefore be considered within the scope of the invention.

We claim:

1. A method of classifying packet information using content addressable memory (CAM), the method comprising the step of:
receiving a set of reconfigurable selection criteria from a user wherein said set of selection criteria is limited by CAM constraint.

2. A method as defined in claim 1 further comprising, in any operative sequence, the steps of:
receiving packet information;
determining packet structure of said packet information;
storing said packet information into packet memory;
generating at run time a bit mask based on said determined packet structure and said received set of selection criteria; and
generating a search key using said bit mask and said packet information stored in packet memory.

3. A method as defined in claim 2 further comprising, in any operative sequence, the step of:
using said search key to do a search or a lookup in the classification database contained in a CAM to determine the rule or policy of said packet information.

4. A method as defined in claim 2 wherein said generation of said search key is via a sequential serial approach wherein the index locations of all 1's in said bit mask are determined, the corresponding offset values retrieved from said packet memory, and said corresponding retrieved values are packed or collected to generate said search key.

5. A method as defined in claim 2 wherein said generation of said search key is via a fully parallel approach wherein the index locations of all 1's in said bit mask are determined, the corresponding offset values retrieved from said packet memory, and said corresponding retrieved values are packed or collected to generate said search key in one clock cycle.

6. A method as defined in claim 2 wherein said generation of said search key is via a semi-parallel approach wherein said bit mask is processed in multiples of certain bits (submasks) until the complete said bit mask is processed, and the index locations of all 1's in each submask are determined, the corresponding offset values retrieved from said packet memory, and said corresponding retrieved values are packed or collected to generate said search key.

7. A content addressable memory (CAM) controlling hardware wherein said CAM controlling hardware
receives a set of reconfigurable selection criteria from a user wherein said selection criteria is limited by CAM constraint.

8. A CAM controlling hardware as defined in claim 7 wherein said CAM controlling hardware further
receives packet information;
determines packet structure of said packet information;
stores said packet information into packet memory;
generates at run time a bit mask based on said determined packet structure and said received set of selection criteria; and
generates a search key using said bit mask and said packet information stored in packet memory.

9. A CAM controlling hardware as defined in claim 8 wherein said CAM controlling hardware further
uses said search key to do a search or a lookup in the classification database contained in a CAM to determine the rule or policy of said packet information.

10. A CAM controlling hardware as defined in claim 8 wherein said generation of said search key is via a sequential serial approach wherein the index locations of all 1's in said bit mask are determined, the corresponding offset values retrieved from said packet memory, and said corresponding retrieved values are packed or collected to generate said search key.

11. A CAM controlling hardware as defined in claim 8 wherein said generation of said search key is via a fully parallel approach wherein the index locations of all 1's in said bit mask are determined, the corresponding offset values retrieved from said packet memory, and said corresponding retrieved values are packed or collected to generate said search key in one clock cycle.

12. A CAM controlling hardware as defined in claim 8 wherein said generation of said search key is via a semi-parallel approach wherein said bit mask is processed in multiples of certain bits (submasks) until the complete said bit mask is processed, and the index locations of all 1's in each submask are determined, the corresponding offset values retrieved from said packet memory, and said corresponding retrieved values are packed or collected to generate said search key.

13. An integrated circuit containing a content addressable memory controlling hardware as defined in claim 7.

14. An integrated circuit containing a content addressable memory controlling hardware as defined in claim 8.

15. An integrated circuit containing a content addressable memory controlling hardware as defined in claim 9.

16. An integrated circuit containing a content addressable memory controlling hardware as defined in claim 10.

17. An integrated circuit containing a content addressable memory controlling hardware as defined in claim 11.

18. An integrated circuit containing a content addressable memory controlling hardware as defined in claim 12.

19. A packet classifier system comprising:
a content addressable memory (CAM) controlling hardware that generates a CAM search key based on a set of reconfigurable selection criteria provided by a user and a bit mask generated at run time based on the packet structure of a packet information received; and
a packet memory.

20. A router or switch comprising
an integrated circuit containing a content addressable memory (CAM) controlling hardware which interfaces with an ingress manager by receiving packet information, which interfaces with a CAM to do a search or lookup on the classification database contained in said CAM, which interfaces with an action content database (RAM/Memory) to do a memory read, and which interfaces with an egress manager which sends out packet information.

21. A method of enabling a user to reconfigure a router or switch, the method comprising:
providing a user interface wherein said user is able to define a set of reconfigurable selection criteria to determine a CAM search key; and
receiving said selection criteria.

22. A method as defined in claim 21 further comprising the step of:
providing information regarding the CAM constraint.

23. A method as defined in claim 22 wherein said CAM constraint is the CAM search key size.

24. A method as defined in claim 21 further comprising, in any operative sequence, the step of
providing a selection of predefined classification templates retrieved from data store from which said user may select one or more of said classification templates to define said set of selection criteria.

25. A method as defined in claim 21 further comprising, in any operative sequence, the step of:
providing a selection of available fields from various network protocols retrieved from data store from which said user may select one or more of said fields to define said set of selection criteria..

26. A method as defined in claim 25 wherein said selection of available fields changes depending on what set of selection criteria has already been defined by said user.

27. A computer software product for use in a computer system that executes program steps recorded in a computer-readable media to perform a method for enabling a user to reconfigure a router or switch, the method comprising:
a) a recordable media; and
b) a program of computer-readable instructions executable by the computer to perform method steps comprising:
i) providing a user interface wherein said user is able to define a set of reconfigurable selection criteria to determine a CAM search key; and
ii) receiving said selection criteria.

28. A computer software product as defined in claim 27 wherein said program perform method steps further comprising, in any operative sequence, the step of:
providing information regarding the CAM constraint.

29. A computer software products as defined in claim 28 wherein said CAM constraint is the CAM search key size.

30. A computer software products as defined in claim 27 wherein said program perform method steps further comprising, in any operative sequence, the step of:
providing a selection of predefined classification templates retrieved from data store from which said user may select one or more of said classification templates to define said set of selection criteria.

31. A computer software products as defined in claim 27 wherein said program perform method steps further comprising, in any operative sequence, the step of:
providing a selection of available fields from various network protocols retrieved from data store from which said user may select one or more of said fields to define said set of selection criteria.

32. A computer software products as defined in claim 31 wherein said selection of available fields changes depending on what set of selection criteria has already been defined by said user.

33. An apparatus that enables a user to reconfigure a router or switch, the method comprising:
a) a central processing unit;
b) a storage device;
c) a processor connected to the storage device wherein the storage device stores:
i) at least one program component for controlling the processor; and
d) the processor is operative with said program component to:
i) provide a user interface wherein said user is able to define a set of reconfigurable selection criteria to determine a CAM search key; and
ii) receive said selection criteria.

34. An apparatus as defined in claim 33 wherein said processor is operative with said program component to further: provide information regarding the CAM constraint.

35. An apparatus as defined in claim 34 wherein said CAM constraint is the CAM search key size.

36. An apparatus as defined in claim 33 wherein said processor is operative with said program component to further:
provide a selection of predefined classification templates retrieved from data store from which said user may select one or more of said classification templates to define said set of selection criteria.

37. An apparatus as defined in claim 33 wherein said processor is operative with said program component to further:
provide a selection of available fields from various network protocols retrieved from data store from which said user may select one or more of said fields to define said set of selection criteria.

38. An apparatus as defined in claim 37 wherein said selection of available fields changes depending on what set of selection criteria has already been defined by said user.
